(19) United States
(12) Patent Application Publication
(10) Pub. No.: US 2009/0071810 A1
(43) Pub. Date: Mar. 19, 2009

(54) Dairy switch apparatus and method

(76) Inventors: Jeffrey S. Hanson, Melrose, WI (US); Larry G. Larson, Holmen, WI (US)

Correspondence Address: SMITH LAW OFFICE, 8000 EXCELSIOR DRIVE, SUITE 301, MADISON, WI, 53717, US

(21) Appl. No.: 11/901,258

(22) Filed: Sep. 14, 2007

(51) Int. Cl. H01H 3/00

(52) U.S. Cl. 200/339

(57) ABSTRACT

A switch for use in dairies with reduced cost, improved reliability, and minimal hysteresis. The switch includes a paddle having a first end and a second end. The second end is contacted by another device or animal, and the first end is thereby moved relative to an inductive sensor.

### FIELD AND BACKGROUND OF THE INVENTION

This invention relates generally to switches used in a dairy environment, and more particularly to flexible paddle switches for use in dairies that are reliable and relatively inexpensive.

Throughout dairies, motion detection, contact and other types of switches are used to sense movement and the presence of animals and machinery. Near-constant usage and the harsh conditions of a dairy cause switches to break and malfunction. Replacing switches can cause equipment downtime, high maintenance costs, and reduced automation in dairies.

Standard switches include mechanical and electrical components that must be shielded from dairy conditions, and repaired or replaced regularly. Even when such components remain operable, their reliability can be compromised by dirt and debris.

There is a need for more efficient and reliable switches with reduced manufacturing, installation, and maintenance costs.

### SUMMARY OF THE INVENTION

The present invention is directed to a simple and reliable switch for use on machinery and for detection of cow movement. The switch is preferably a paddle switch that is mounted on a moving piece of equipment or on a fixed structure in a dairy. The switch includes a paddle made of a material such as polyurethane sheet stock or other suitable material or combination of materials. The switch paddle has a mounting portion about which the paddle pivots, and which is preferably mounted at a location that is offset from the paddle midpoint. The mounting is secure enough to permit the rest of the switch paddle to pivot about a pivot line when contacted by other equipment, animals or structures.

The switch has a first end and a second end, and a metal clip is joined to the first end of the switch so that an inductive sensor can sense the position of the paddle. When the second end of the switch moves, the first end and metallic clip also move and are detected by the inductive sensor. The inductive sensor then transmits a signal via wires, wireless, or other conduit to a signal receiving device. The switch can be single acting or double acting to sense movement in one or two directions, respectively, or to send signals to multiple receivers.

The switch paddle may have a uniform thickness. The switch paddle may also have different heights at various portions along its length. For example, the mounting portion may have a greater height than the height of the paddle first and/or second ends. The first end may have a height that is greater than the height of the second end. These variations in height enable the first and second end to pivot to different degrees from one another and enable the mounting portion or adjacent areas to act as a “living hinge” that permits resilient bending without the need for additional mechanical components.

The present invention is directed to a switch that: has few moving parts; is resistant to being fouled by dirt, debris, and water; and is relatively inexpensive to make, install, and maintain.

In addition, a switch in accordance with the present invention reduces the possibility of “false triggers” and has minimal hysteresis. Instead, the dairy switch reliably detects movement, and responds and resets quickly and reliably.

### BRIEF DESCRIPTION OF THE DRAWINGS

FIG. 1 is a side view of a switch in accordance with the present invention;

FIG. 2 is a perspective view of the switch of FIG. 1 mounted on a support structure;

FIG. 3 is a partial perspective view of a rotary milking parlor with a switch in accordance with the present invention; and

FIG. 4 is an end view of a cow counting gate incorporating a switch in accordance with the present invention.

FIG. 5 is a side view of a switch paddle in accordance with the present invention.

### DETAILED DESCRIPTION OF THE PREFERRED EMBODIMENTS

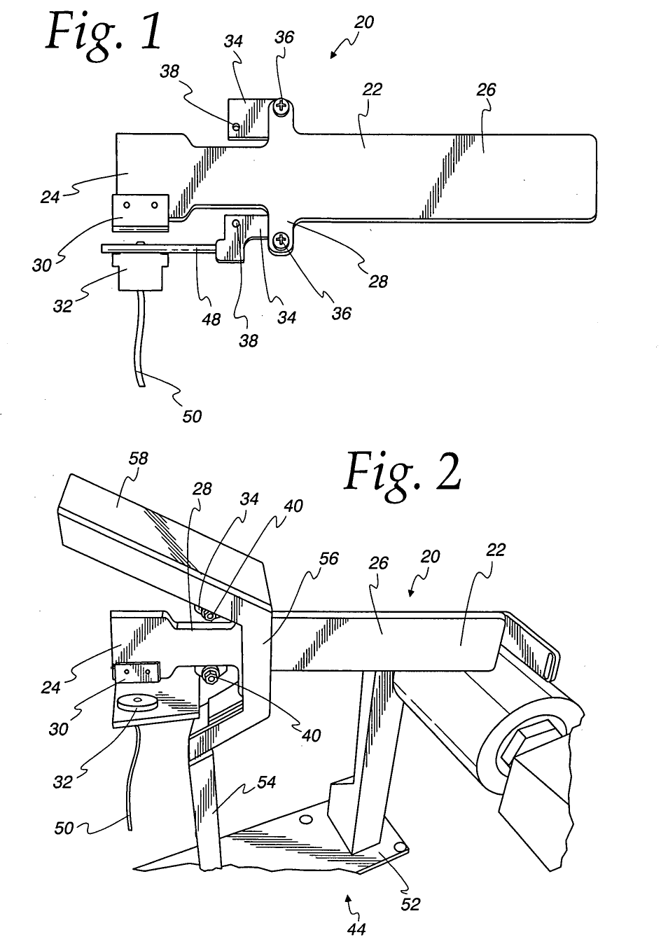

In the following detailed description of the preferred embodiments, the same reference numeral will be used to identify the same element in each of the figures. As illustrated in FIGS. 1 and 2, there is a switch 20 in accordance with the present invention.

The switch 20 includes: a paddle 22 having a first end 24, a second end 26, a mounting portion 28, and a metallic clip 30 joined to the first end 24, and an inductive sensor 32.

The paddle 22 mounting portion 28 is disposed between the first end 24 and the second end 26. The first end 24 and the second end 26 pivot about the mounting portion 28 when the switch 20 is being activated. The paddle 22 is preferably made of a material such as polyurethane that is able to withstand dairy conditions, is inexpensive, and can be formed into a variety of useful shapes. The paddle 22 can be any shape, but a shape in which the first end 24 is shorter than the second end 26 is preferred so that the first end 24 is responsive to even slight movements of the second end 26. A more detailed description of preferred paddle 22 dimensions is provided below.

The second end 26 can be any shape and length, and will be sized according to its application. For example, when the switch 20 is used to detect relative movements of machinery, the second end 26 need only be long enough to span the distance between adjacent mechanical components. When used to detect cow movement, for example, the second end 26 can extend across as much of a gate or alley as necessary to ensure contact by cows passing through.

As stated above, the first end 24 and the second end 26 are separated by the mounting portion 28. The mounting portion 28 can be of any shape that is suitable for mounting in any given application. The mounting portion 28 can be made entirely of the same material as the rest of the paddle 22 as in the illustrated embodiment or include other materials such as mounting plates 34. The mounting plates 34 are metal in the preferred embodiment and are joined to the mounting portion 28 with screws 36 or other suitable connectors. Other mounting plate 34 materials could be used. The mounting plates 34 include holes 38 through which bolts, screws, nails or other switch mount connectors 40 (FIG. 2) secure the switch 20 to a structure 44. Alternatively, the mounting plates 34 can be welded or otherwise secured to a structure 44.

The mounting plates 34 are typically not flexible while the paddle 22 is flexible to obviate the need for hinges or other mechanical or spring-loaded devices. This arrangement acts like a “living hinge” to give the desired flexibility and performance.

FIG. 5 illustrates dimensions and relative dimensions for a paddle 22 in accordance with the present invention. Optimal dimensions will depend upon the specific application to which the paddle 22 will be put, but the following general description will enable one skilled in the art to make and use the present invention.

Preferably, the thickness of the material should be adequate to give the paddle 22 adequate rigidity over its span. Overall dimensions must also accommodate material removed for bore holes and possibly material gradually lost to wear and tear. Preferably, the thickness of all portions of the paddle 22 is substantially uniform throughout, but varying thicknesses could be used to modify performance or reduce weight, for example.

As stated above, the paddle 22 includes a first end 24, a second end 26, and a mounting portion 28. The first end 24 may include an end portion 90 and neck portion 92. The neck portion 92 has a height dimension A. The end portion 90 size may be adjusted to suit the specific sensor and bracket needs.

The mounting portion 28 has a width J and a height dimension B between mounting holes 94. The paddle 22 end portions pivot about an axis L. Width J of the transition portion 28 is selected to ensure that the pivot axis L will withstand repetitious movement and be resilient enough to return the paddle 22 to a home (unpivoted) position. Transition fillets 98 are used between the mounting portion 28 and the second end portion 26 to reduce stress concentrations and avoid possible sharp corners on which animals or machinery could catch. The second end portion 26 in the illustrated embodiment has a uniform height of dimension C, but varying heights could be used.

Preferably, the mounting portion 28 has a height dimension B that is larger than the second end 26 height dimension C so that rotation about axis L will be translated to a relatively small amount of pivoting movement of the paddle first end 24. This differential in heights causes the axis L to behave as a “living hinge” that flexes without the aid of separate mechanical hinges or other mechanical components, while simultaneously withstanding harsh dairy use.

The differential height also translates pivoting movement in varying degrees between the second end 26 and the first end 24. Thus, the amount of pivoting movement desired in the first end 24 can be selected by varying the relative height dimensions of the paddle 22 parts. The larger the mounting portion 28 dimension B relative to the second end 26 dimension C the greater amount of pivoting that takes place in the first end 24. If dimension B is too small relative to dimension C, stress fractures can occur in the fillet 98. If dimension B is too large relative to dimension C, the second end 26 may not return reliably back to its home (straightened) position. Preferably, dimension B is about one inch to about ten inches greater in height than dimension C.

Dimension A of the first end 24 is preferably smaller than dimension C to transmit pivoting movement from the second end 26 to the first end 24. In general, the second end 26 may pivot as much as about 180 degrees in either direction about the axis L, while the first end 24 will pivot in the opposite direction, but typically only up to about forty-five degrees. It may go up to 90 degrees in either direction, depending on the other dimensions.

If desired, the first end 24 dimension A could be smaller than the second end 26 dimension C, to cause the first end 24 to pivot a greater amount than the second end 26.

The flexibility of the paddle 22 depends on material properties as well. Preferably, the material has a Durometer A95, but others could be used.

Another manner of determining paddle dimensions is the use of ratios for the various ends and mounting portions. The following chart lists unit lengths that are useful in the present invention.

| Movement of | Movement of | | |
|---|---|---|---|
| Location F from | Location G from | Length | |
| Center (outside | Center (as a result | of Location | Length of |
| force pushing or | of an outside force | G to axis at | Location F to |
| pulling location) | at Location F). | Location L | axis at Location L |
| 1 | 1 | 1 | 1 |
| 1 | ½ | 1 | 2 |
| 1 | 2 | 2 | 1 |

In the example of a paddle switch 20 being used in conjunction with a rotary milking parlor, a suitable paddle switch 20 will be made of a nominal quarter-inch thickness polyurethane, having a paddle 22, 13.5 inches long; a first send 24, 4.25 inches long; a second end 26, 8.55 inches long; and a mounting portion 28, 2.70 inches long.

The first end 24 includes an end portion 90 that is 1.75 inches long and 2.25 inches high; and a neck portion 92 that is 2.5 inches long and 1.55 inches high. The second end 26 is 2.25 inches long, and has a 0.25 inch hole 98, 2.12 inches from the distal end of the second end 26. The mounting portion is 4.1 inches high. All corners preferably have a 0.25 inch radius with the exception of the distal end of the second end 24, which preferably has square corners.

All dimensions provided above are specified, but manufacturing tolerances and nominal material thickness tolerances may affect actual dimensions of a manufactured product.

In any of these examples, the mounting plates 34 act as a “living hinge” that permits movement of the paddle 22, but requires no mechanical hinges or separate springs, although springs could be used to enhance responsiveness.

Preferably, the paddle 22 is a nominal ¼″ polyurethane and the mounting plates are 0.105″ stainless steel. Alternatively, the mounting plates 34 are of a thickness and material that enable them to be flexible when the second end 26 of the paddle 22 is moved during activation. The flexibility and resiliency of the mounting plates 34 in this alternative obviates the need for hinges or other mechanical and spring-loaded devices.

Preferably when sensing animal movements, the mounting portion 28 is joined to a structure 44 so that the second end 26 is a length that is two-thirds to three-quarters of the total paddle 22 length. The length of the second end 26 will depend on the item to be contacting the second end 26 and the sensitivity of the inductive sensor 32. For example, a gate sensor may use a first end 24 longer than the second end 26 of the paddle 22 because a gate sensor would require a longer travel of the first end 24 for proper sensing of gate movement.

The mounting plates 34 are depicted as separate components attached to the mounting portion 28 of the paddle 22, but the mounting plates 34 could be the same material as the paddle 22 or formed integrally with the mounting portion 28 of the paddle 22.

In use, the second end 26 is contacted by an object or animal and the paddle 22 pivots about the mounting portion 28. The first end 24 also pivots and moves relative to the inductive sensor 32. When the paddle 22 second end 26 is not being contacted, it is in a “home” position. When the paddle 22 second end 26 is being contacted, it is in an “activated” position. The paddle 22 is biased toward and returns to the “home” position due to the resiliency of the mounting portion 28 or by the use of separate springs.

The first end 24 of the paddle 22 has the metallic clip 30 joined thereto, as described above. The metallic clip 30 is disposed at a position to interact with the inductive sensor 32. In the illustrated embodiment, the inductive sensor 32 is mounted on an extension 48 of a mounting plate 34 to further simplify design and reduce costs, but other types of holders could be used to mount the sensor 32 in an appropriate position.

The inductive sensor 32 can be any senor that operates by electromagnetic induction and responds to movement of an object made of a ferromagnetic material, such as the metallic clip 30 in the illustrated preferred embodiment. The sensor 32 is inductive so that it does not sense dirt and water that may get into the enclosure or otherwise affect other types of sensors. Movement of the ferromagnetic material adjacent the sensor causes a voltage to be created that is transmitted through wire 50, other conduit, or to be used to transmit a wireless signal to an appropriate receiver (not illustrated). The sensitivity of the inductive senor 32 can be selected for an appropriate application or be adjustable for tuning in the field during installation and maintenance. In a preferred embodiment, the sensor 32 is a 30 mm inductive sensor. The sensor 32 is preferably adjustable in sensitivity range from 30 mm to 1 mm. This adjustment may be made via adjustment of the sensor itself, or it may be made by adjusting the sensor 32 in the mounting plate 48, which could be any type of holder. In the preferred embodiment, there is adjustment in the holder 48 left and right of up to 1 cm either side of the preferred sensing location to allow for fine tuning of the sensitivity.

The inductive sensor 32 can also be single action or double action. In a single action application, one inductive sensor 32 is used to sense movement of the paddle 22. In a double action application, there is a pair of inductive sensors 32 mounted near the metallic clip (preferably, one on each side of the clip) 30 so that each inductive sensor 32 sends a signal. An example of a double action sensor 32 application is a personnel or animal sensor that senses movement in both directions. The second end 26 of the paddle 22 responds to movement in both directions and the first end 24 with metallic clip 30 will move adjacent one of the sensors 32 regardless of which way the person or animal is moving.

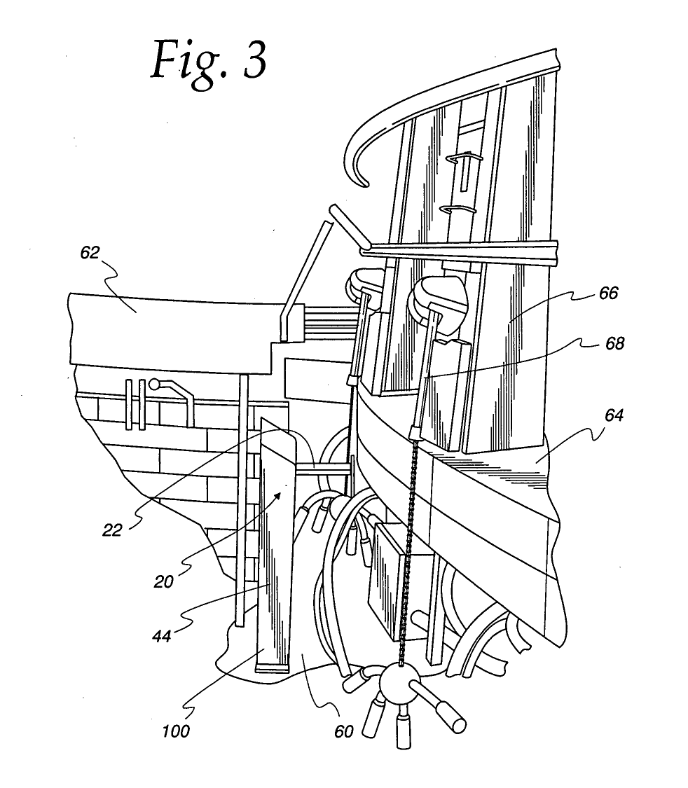

The switch 20 can be mounted on a structure 44 that is movable or stationary. For example, FIG. 2 illustrates the switch 20 mounted on a stationary structure 44 that can be factory-made and mounted to a floor, wall, ceiling or a piece of dairy equipment in a dairy. The structure 44 illustrated in FIG. 2 includes a base 52, a post 54, and a mount 56. A shield 58 is also provided for deflecting debris and water from the switch's electronic components. A back cover 100 (FIG. 3) can be used for enclosing much of the switch 20 components to keep out most of any dirt and water in the area. Of course, the paddle 22 second end 26 extends out to be engaged by the necessary machinery or animals. The structure 44 can be made of any suitable material, such as stainless steel, aluminum, or plastic.

FIG. 3 illustrates a portion of a rotary milking parlor having a floor 60, a stationary platform 62, a rotating platform 64, and milking machines 66 with detacher arms 68. The detacher arms 68 are raised and lowered depending upon whether the rotary platform 64 is in a position for milking cows or in a rest position.

A stand structure 44 is mounted on the floor 60 with a switch 20 mounted thereon to determine the position of the rotating platform 64 and whether the detacher arms are in a desired position.

The switch 20 in such an embodiment has a second end 26 that is sized and positioned to be contacted by detacher arm chain, milking unit, pulsation hose, or milk hose 72 that is joined to the rotating platform 64. The switch 20 is then activated as the detacher arm chain, milking unit, pulsation hose, or milk hose 72 rotates past the stationary switch 20. Alternatively, the switch 20 could be mounted on the rotating platform 64 and arranged to contact a stationary component.

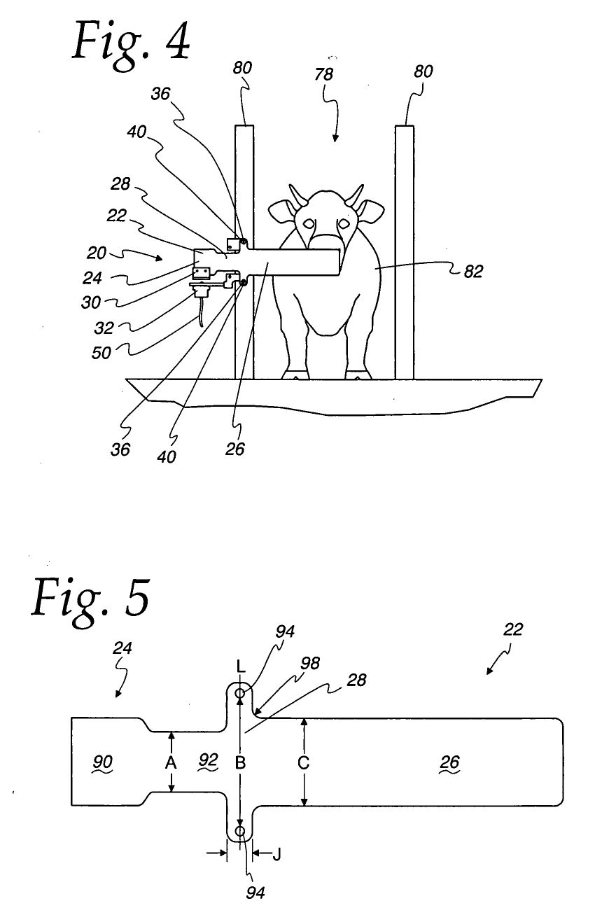

FIG. 4 illustrates a switch 20 in accordance with the present invention and disposed in a cow alley or gate 78. The alley 78 includes a pair of spaced apart fences 80. This switch 20 includes a first end 24, a second end 26, a mounting portion 28, a metallic clip 30, and an inductive sensor 32. The switch 20 is mounted to the fence 80 with suitable fasteners 36. In this embodiment, the second end 26 is sized to be contacted by a cow 82 as it passes the switch 20, but not so large that the cow 82 is discouraged from walking through.

The foregoing detailed description of the invention is intended for clearness of understanding the present invention, and no unnecessary limitations therefrom should be read into the following claims.

1. A switch for use in a dairy, the switch comprising:
a paddle having a first end, a second end, and a mounting portion disposed between the first end and the second end, the first end has a first size and the second end has a second size that is different from the first size, and the mounting portion is sized so that the second end and the first end have different degrees of pivoting movement about the mounting portion when the second end is pivoted by an external force;
a metallic clip joined to the paddle first end; and
an inductive sensor disposed adjacent to the metallic clip, for generating a signal when the metallic clip moves relative to the inductive sensor.

2. The switch of claim 1 wherein:
the paddle is made of polyurethane.

3. The switch of claim 1, wherein:
the first end has a shorter length than the length of the second end.

4. The switch of claim 1, wherein:
the second end length is between about two-thirds and about three-quarters of a total length of the paddle.

5. The switch of claim 1, and further comprising:
a mounting plate joined to the mounting portion.

6. The switch of claim 1, and further comprising:
a stationary structure on which the mounting portion of the switch is mounted.

7. (canceled)

8. The switch of claim 1, wherein:
the mounting portion of the paddle is resilient and the paddle returns to a home position when the second end of the paddle is not engaged.

9. The switch of claim 1, wherein the paddle second end has a height dimension that is less than a height dimension of the mounting portion.

10. The switch of claim 1, wherein the paddle first end has a height dimension that is greater than a height dimension of the second end.

11. The switch of claim 1, wherein the paddle first end has a height dimension that is less than a height dimension of the mounting portion and a greater than a height dimension than the height dimension of the second end.

12. The switch of claim 1, wherein the paddle first end has a height dimension that is less than a height dimension of the second end.

13. The switch of claim 11, wherein the paddle has a substantially uniform thickness.

14. The switch of claim 1, wherein the first end comprises a neck portion adjacent to the mounting portion and an end portion adjacent to the neck portion.
